(19) United States
(12) Patent Application Publication
(10) Pub. No.: US 2005/0254720 A1
(43) Pub. Date: Nov. 17, 2005

(54) Enhanced surgical visualizations with multi-flash imaging

(76) Inventors: Kar-Han Tan, Champaign, IL (US); Ramesh Raskar, Cambridge, MA (US); Paul H. Dietz, Hopkinton, MA (US)

Correspondence Address: Patent Department;Mitsubishi Electric Research Laboratories, Inc., 201 Broadway, Cambridge, MA, 02139, US

(21) Appl. No.: 10/847,069

(22) Filed: May 17, 2004

(51) Int. Cl. H01J 40/14

(52) U.S. Cl. 382/254

(57) ABSTRACT

A method enhances an output image of a 3D object. A set of input images are acquired of a 3D object. Each one of the input images is illuminated by a different one of a set of lights placed at different positions with respect to the 3D object. Boundaries of shadows are detected in the set of input images by comparing the set of input images. The boundaries of shadows that are closer to a direction of the set of lights are marked as depth edge pixels.

### RELATED APPLICATION

This application is related to U.S. patent application Ser. No. 10/______, titled “Stylized Rendering Using a Multi-Flash Camera,” co-filed herewith by Raskar on May 17, 2004, and incorporated herein by reference.

### FIELD OF THE INVENTION

This invention relates generally to endoscopy, and more particularly to enhancing images acquired by endoscopes.

### BACKGROUND OF THE INVENTION

In many medical procedures, such as minimal-invasive surgery with endoscopes, it is often difficult to acquire images that convey a 3D shape of the organs and tissues being examined, Vogt, F., Kruger, S., Niemann, H., Schick, C., “A system for real-time endoscopic image enhancement,” MICCAI, 2003. Most endoscopic procedures are performed by a surgeon viewing a monitor rather than the actual anatomy through the endoscope.

Depth perception is impossible when using monocular endoscopes. Three-dimensional imaging using stereoscopic methods provide mixed results. A 1999 study found that stereo-endoscopic viewing was actually more taxing on the surgeons than monocular viewing, Mueller, M., Camartin, C., Dreher, E., Hanggi, W., “Three-dimensional laparoscopy, gadget or progress, a randomized trial on the efficacy of three-dimensional laparoscopy,” Surg Endosc. 13, 1999.

Structured lighting is also known as a means for calibrating endoscopic images, Rosen, D., Minhaj, A., Hinds, M., Kobler, J., Hillman, R., “Calibrated sizing system for flexible laryngeal endoscopy,” Proceedings of 6^{th} International Workshop: Advances in Quantitative Laryngology, Advances in Quantitative Laryngology, Voice and Speech Research, Verlag, 2003. However, that technique does not provide real-time enhancement of 3D structures. Consequently, that technique is of no use to a surgeon performing endoscopy.

Shadows normally provide clues about shape. However, with ‘ringlight’ or circumferential or illumination provided by most conventional laparoscopes, shadow is diminished.

Similarly, intense multi-source lighting used for open procedures tends to reduce strong shadow effects. Loss of shadow information makes it difficult to appreciate the shapes and boundaries of structures. Thus, it is more difficult to estimate an extent and size of the structures. Intense lighting also makes it difficult to spot a small protrusion, such as an intestinal polyp, when there are no clear color differences.

The ability to enhance boundaries of lesions, so that the lesions can be measured, will become more useful when endoscopes incorporate calibrated sizing features.

Stylized Images

Recently, a number of methods have been described for generating and rendering stylized images without the need for first constructing a 3D graphics model. The majority of the available methods for image stylization involve processing a single input image by applying morphological operations, image segmentation, edge detection and color assignment.

Some of those methods provide stylized depiction, DeCarlo, D., Santella, A., “Stylization and Abstraction of Photographs,” Proc. Siggraph 02, ACM Press., 2002. Other methods enhance legibility. Interactive methods for stylized rendering, such as rotoscoping, have also been used, “Waking Life: Waking Life, the movie,” 2001, and Avenue Amy: Curious Pictures, 2002.

Stereo methods, which use passive and active illumination, are generally designed to determine depth values or surface orientation, rather than to detect depth edges. Depth discontinuities present difficulties for traditional stereo methods. Those methods fail due to half-occlusions, which confuse a matching process, Geiger, D., Ladendorf, B., Yuille, A. L., “Occlusions and binocular stereo,” European Conference on Computer Vision, pp. 425-433, 1992.

Some methods attempt to model the depth discontinuities and occlusions directly, Intille, S. S., Bobick, A. F., “Disparity-space images and large occlusion stereo,” ECCV (2), pp. 179-186, 1994, Birch. eld, S., Tomasi, C., “Depth discontinuities by pixel-to-pixel stereo,” International Journal of Computer Vision 35, pp. 269-293, 1999, and Scharstein, D., Szeliski, R., “A taxonomy and evaluation of dense two-frame stereo correspondence algorithms,” International Journal of Computer Vision, Volume 47 (1). pp. 7-42, 1999.

Active illumination methods have been described for depth extraction, shape from shading, shape-time stereo and photometric stereo. However, active illumination is unstable around depth discontinuities, Sato, I., Sato, Y., Ikeuchi, K., “Stability issues in recovering illumination distribution from brightness in shadows,” IEEE Conf. on CVPR, pp. 400-407, 2001.

Another method performs logical operations on detected intensity edges, captured under widely varying illumination, to preserve shape boundaries, Shirai, Y., Tsuji, S., “Extraction of the line drawing of 3-dimensional objects by sequential illumination from several directions,” Pattern Recognition 4, pp. 345-351, 1972. However, that method it is limited to uniform albedo scenes.

With photometric stereo, it is possible to analyze intensity statistics to detect high curvature regions at occluding contours or folds, Huggins, P., Chen, H., Belhumeur, P., Zucker, S., “Finding Folds: On the Appearance and Identification of Occlusion,” IEEE Conf. on Computer Vision and Pattern Recognition. Volume 2., IEEE Computer Society, pp. 718-725, 2001. However, that method assumes that the surface is locally smooth. Therefore, that method which fails for a flat foreground object, like a leaf or piece of paper, or view-independent edges such as corner of a cube. That method detects regions near occluding contours but not the contours themselves.

Methods for extracting shape from shadow or darkness require a continuous representation or ‘shadowgram’. If a moving light source is used, then continuous depth estimates are possible, Raviv, D., Pao, Y., Loparo, K. A., “Reconstruction of three-dimensional surfaces from two-dimensional binary images,” Transactions on Robotics and Automation, Volume 5 (5), pp. 701-710, 1989, and Daum, M., Dudek, G., “On 3-D surface reconstruction using shape from shadows,” CVPR, pp. 461-468, 1998. However, that method involves estimating continuous heights and requires accurate detection of start and end of shadows. That is very difficult.

A survey of shadow-based shape analysis methods are described by Yang, D. K. M., “Shape from Darkness Under Error,” PhD thesis, Columbia University, 1996, and Kriegman, D., Belhumeur, P., “What shadows reveal about object structure,” Journal of the Optical Society of America, pp. 1804-1813, 2001.

### SUMMARY OF THE INVENTION

The invention enhances images and video acquired by endoscopy in real-time. The enhanced images improve shape details in the images. The invention uses multi-flash imaging. In multi-flash imaging, multiple light sources are positioned to cast shadows along depth discontinuities in anatomical scenes.

The images can be acquired by a single or multiple endoscopes. By highlighting detected edges, suppressing unnecessary details, or combining features from multiple images, the resulting images clearly convey a 3D structure of the anatomy.

### BRIEF DESCRIPTION OF THE DRAWINGS

FIG. 1 is a schematic of a shadow cast by an object illuminated according to the invention;

FIG. 2 is a flow diagram of a method for enhancing images according to the invention;

FIG. 3 is a prior art anatomical image;

FIG. 4 is an anatomical image rendered according to the invention;

FIG. 5 is a side view of multiple endoscopes according to the invention; and

FIG. 6 is an end view of a single endoscope according to the invention.

### DETAILED DESCRIPTION OF THE PREFERRED EMBODIMENT

Multi-Flash Imaging

A method according to our invention enhances anatomical shapes in surgical visualizations. The method uses multi-flash imaging. The method is motivated by the observation that when a light illuminates a scene during image acquisition, thin slivers of cast shadows are visible at depth discontinuities. Moreover, locations of the shadows are determined by a relative position of a camera and a light source, e.g., a flash unit. When the light is on the right, the shadows are on the left, and when the light is on the left, the shadow is on the right. Similar effects are obtained with up and down locations of the lights.

Thus, if a sequence of images is obtained with light sources at different locations, we can use the shadows in each image to construct a depth edge map using the shadow images.

Imaging Geometry

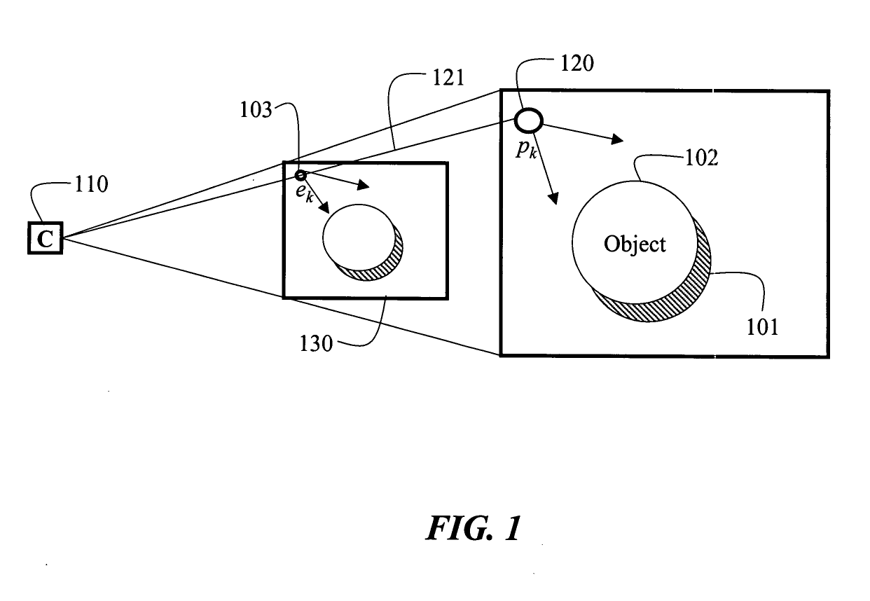

FIG. 1 shows how a location of cast shadow 101 of an object 102 is dependent on a relative position of a camera 110 and point light source 120. Adopting a pinhole camera model, a projection 121 of the point light source 120 at a point Pₖ is at pixel eₖ 103 in an image 130. We call this projection of the light source a light epipole. The images of an infinite set of light rays originating at point Pₖ are in turn called the epipolar rays originating at the epipole eₖ.

Detecting and Removing Shadows

Our method strategically positions multiple light sources so that every point in a scene that is shadowed in some image is also imaged without being shadowed in at least one other image. This can be achieved by placing the lights strategically so that for every light there is another light at an opposite side of the camera. Therefore, all depth edges are illuminated from at least two sides. Also, by placing the lights near a lens of the camera, we minimize changes across images due to effects other than shadows. Therefore, one input image is acquired of the scene for each light source.

To detect shadows in each image, we generate a shadow-free maximum image. The maximum image is assembled by selecting, for each pixel in the maximum image, a corresponding pixel inn any of the input images with a maximum intensity value. The shadow-free image is then compared with the individual shadowed input images. In particular, for each shadowed input image, we determine a ratio image by performing a pixel-wise division of the intensity of the input image by the maximum image.

Pixels in the ratio image are close to zero at pixels that are not shadowed, and close to zero at pixels that are shadowed. This serves to accentuate the shadows and also to remove intensity transitions due to surface material texture changes.

Method Operation

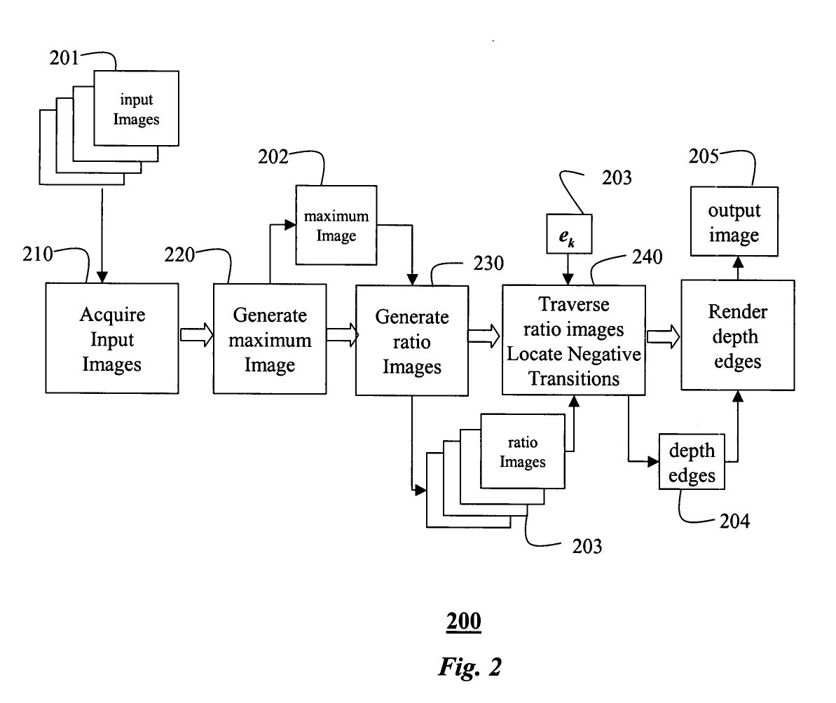

FIG. 2 shows a method 200 for enhancing images according to the invention. For n light sources located at positions P₁, P₂, . . . , Pₙ, acquire 210 a set of n input images 201 Iₖ, k=1, . . . , n, with a light source at positions Pₖ.

Generate 220 a maximum image 202, Imax(x)=max k(Iₖ(x)), k=1, . . . , n, from all pixels x in the set of input images 201.

For each input image Iₖ, generate 230 a ratio image 203, Rₖ, where
Rₖ(x)=Iₖ(x)/Imax(x).

For each ratio image Rₖ, traverse 240 each epipolar ray from the epipole eₖ 103, and locate pixels y with step edges with negative intensity transition, and mark the pixel y as a depth edge pixels.

The depth edge pixels can be rendered 250, in an output image 205, using some rendering enhancement technique. For example, the appearance of the depth edge pixels can be enhanced by rendering the depth edge pixels in a black color. It should be noted, that in a ‘dark’ image, the enhancement can render the depth edge pixel as white. That is, the intensity of the enhanced pixels if inversely proportional to an average intensity of the output image. For a color image, a contrasting color can be used.

A base for the output image 205 can be any one of the input images.

It should be noted that the depth edge pixels can be connected into a contour, and the contour can then be smoothed. At T-junctions, unlike traditional methods that select the next edge pixel based on orientation similarity, we use the information from the shadows to resolve the connected contour. It should also be noted that a width of the contour can be increased to make the contour more visible.

It should be noted that instead of taking each picture with one light source one at a time, light multiplexing and demultiplexing can be used to turn on one or more light sources simultaneously in a single image and decoding the contribution of each light in the image. For example, each light emits light with different wavelength, or different polarization. Spread spectrum techniques can also be used.

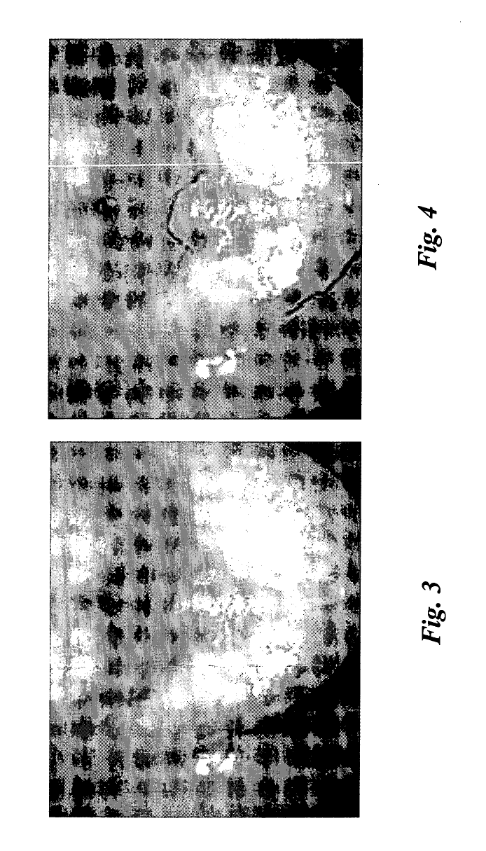

FIG. 3 shows calf larynx rendered using conventional imaging, and FIG. 4 shows the same calf larynx in an output image enhanced according to the invention.

Multi-Flash Imaging with Endoscopes

Unlike many traditional 3D shape recovery methods, where the imaging apparatus need to be placed at large distances apart, in multi-flash imaging the light sources can be placed near to the lens of the camera. This allows compact designs that can be used in tightly constrained spaces.

Multiple Endoscopes

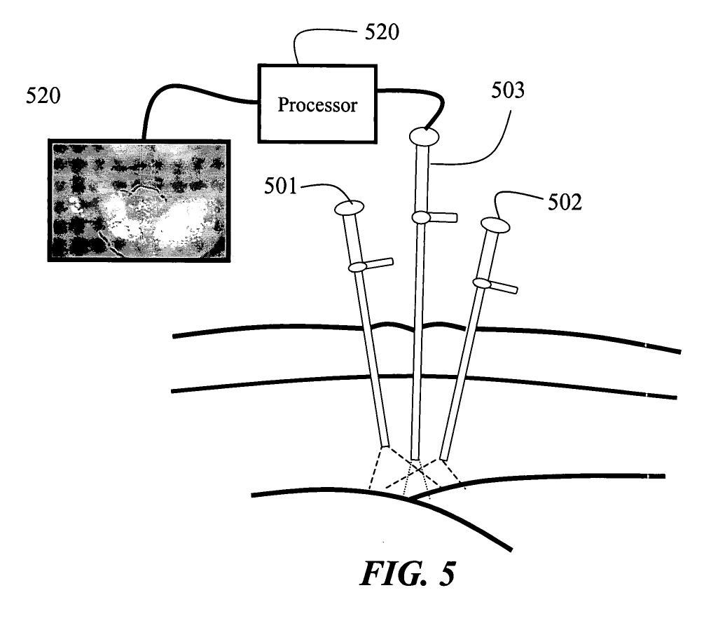

FIG. 5 shows one embodiment of the invention using three endoscopes 501-503. Endoscopes 501-502 are used as point light sources, and endoscope 503 is used as a camera connected, via a processor 510, to a monitor 510. The processor executes the method 200 according to the invention.

By synchronizing the light sources 501-502 with the image acquisition process for the middle endoscope 503, the entire arrangement acts as a multi-flash camera.

Single Endoscope

In many scenarios, it is more useful to have a single instrument capable of multi-flash imaging. For example in situations where flexible endoscopes are needed, it may be very difficult or impossible to insert and align multiple flexible light sources with the endoscope.

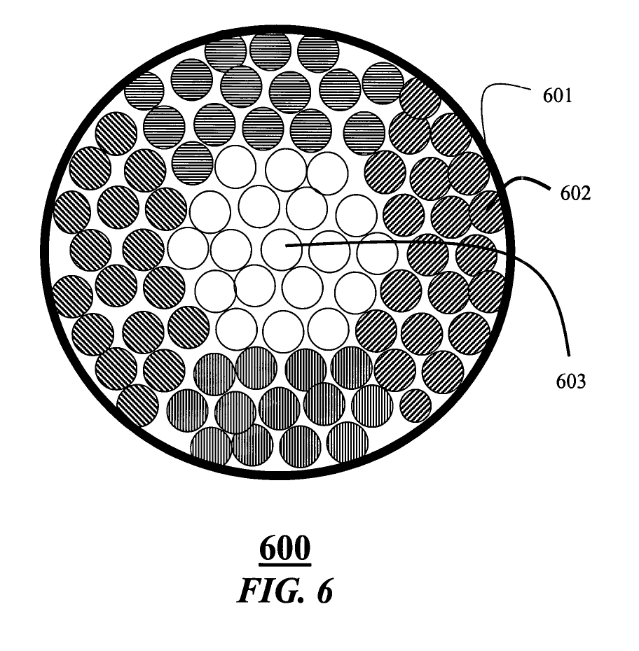

As shown in FIG. 6, the multi-flash imaging according to the invention can be implemented with a single endoscope. FIG. 6 shows schematically an R. Wolf Lumina laryngeal laparoscope endoscope modified to achieve multi-flash imaging.

At the tip of the endoscope 600, there is an imaging lens 601 and numerous optical fibers 602-603. By illuminating some of the fibers, the light is transmitted to the tip, serving as illumination for the imaging lens. When the fibers are illuminated independently, the endoscope 600 is capable of multi-flash imaging.

In FIG. 6, four sets of illuminating fibers 602 are shown by hatching lines. These four bundles constitute the multiple light sources. The ‘open’ fibers 603 are used for image acquisition. It should e understood that the fibers can be bundled in other manners to provide fewer or more light sources.

It is to be understood that various other adaptations and modifications may be made within the spirit and scope of the invention. Therefore, it is the object of the appended claims to cover all such variations and modifications as come within the true spirit and scope of the invention.

1. A method for enhancing an output image, comprising:
acquiring a set of input images of a 3D object, each one of the input images being illuminated by a different one of a set of lights placed at different positions with respect to the 3D object;
generating a maximum image from the set of input images;
dividing each input image by the maximum image to generate a set of ratio images;
detecting depth edge pixels in the set of ratio images; and
enhancing pixels in an output image of the 3D object corresponding to the depth edge pixels.

2. The method of claim 1, in which the depth edge pixels correspond to depth discontinuities in the set of input images.

3. The method of claim 1, in which a particular pixel in the maximum image has a maximum intensity value of any corresponding pixel in any of the set of input images.

4. The method of claim 1, further comprising:
connecting the depth edge pixels into a contour; and
smoothing the contour.

5. The method of claim 1, further comprising:
increasing a width of the depth edge pixels.

6. The method of claim 1, further comprising:
rendering the depth edge pixels in a selected color.

7. The method of claim 6, in which the selected color depends on an average intensity of the output image.

8. The method of claim 1, in which the set of input images are illuminated by first and second endoscopes, and the input is acquired by a third endoscope.

9. The method of claim 1, in which the input images are acquired with an endoscope.

10. The method of claim 9, in which the endoscope includes a plurality of optical fibers, and further comprising:
partitioning the plurality of fibers into a set of bundles;
acquiring the input images with one bundle; and
illumining with the remaining bundles of the set.

11. A method for enhancing an output image of a 3D object, comprising:
acquiring a set of input images of a 3D object, each one of the input images being illuminated by a different one of a set of lights placed at different positions with respect to the 3D object;
detecting boundaries of shadows in the set of input images by comparing the set of input images; and
marking the boundaries of shadows that are closer to a direction of the set of lights as depth edge pixels.

12. The method of claim 11, in which the depth edge pixels are highlighted in the output image to convey shape boundaries of the 3D object.

13. The method of claim 11, in which the detecting further comprises:
generating a maximum image from the set of input images;
dividing each input image by the maximum image to generate a set of ratio images;
marking pixels having minimum light intensity vales in each ratio image as the depth edge pixels.

14. The method of claim 13, in which the marking further comprises:
traversing each ratio image to find transition from illuminated regions to shadowed regions, and marking pixels at the transition as a depth edge pixel.
